(19) United States
(12) Patent Application Publication
(10) Pub. No.: US 2004/0229107 A1
(43) Pub. Date: Nov. 18, 2004

(54) Combined fuel cell and battery

(76) Inventor: Stuart I. Smedley, Escondido, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/437,481

(22) Filed: May 14, 2003

(51) Int. Cl. H01M 4/86

(52) U.S. Cl. 429/40

(57) ABSTRACT

Improved metal/air fuel cells comprise an anode and a cathode in which the cathode provides for gas diffusion and reduction of gaseous oxidizing agents with a catalyst and comprises an initial oxidizing agent. The initial oxidizing agent can be a non-gaseous composition present in the cathode for immediate availability. Due to the presence of the initial oxidizing agent, the metal/air fuel cells can produce current immediately after closing the circuit, regardless of the level, or concentration, of a gaseous oxidizing agent present in the catalytic layer of the cathode. Thus, the improved fuel cells can generate current without a time delay that can be associated with the flow of a gaseous oxidizing agent into the catalytic layer of the cathode.

### FIELD OF THE INVENTION

The invention relates to gas diffusion electrodes for fuel cells, especially as cathodes for metal/air fuel cells. In particular, the invention relates to cathode assemblies comprising a non-gaseous redox active composition that can be reduced prior to the availability of a desired flow of gaseous reactants. The invention further relates to methods for producing current from an electrochemical cell.

### BACKGROUD OF THE INVENTION

Gas diffusion electrodes are suitable for use in electrochemical cells that have gaseous reactants, including for use in the cathode for the reduction, for example, of oxygen, bromine or hydrogen peroxide. The reduction of gaseous molecular oxygen can be an electrode reaction, for example, in metal-air/oxygen batteries, metal-air/oxygen fuel cells and hydrogen-oxygen fuel cells. Oxygen is generally conveniently supplied to these electrochemical cells in the form of air. Fuel cells differ from batteries in that the reactants for the anode and the cathode can both be replenished without disassembling the cells.

The cathode in an electrochemical cell containing an alkaline electrolyte and involving oxygen reduction generally catalyses the reduction of oxygen, which combines with water to form hydroxide ions. The reduction of oxygen removes electrons at the cathode. The oxidation reaction at the anode gives rise to the electrons that flow to the cathode when the circuit connecting the anode and the cathode is closed. The electrons flowing through the closed circuit enable the foregoing oxygen reduction reaction at the cathode and simultaneously can enable the performance of useful work due to an over-voltage between the cathode and the anode.

In one embodiment of a fuel cell, a metal such as, for example, zinc, iron, lithium and/or aluminum, can be used as a fuel. In those embodiments, the oxidation of the metal to a metal oxide or a metal hydroxide at the anode releases electrons which can be used to drive a current in a circuit connecting the anode and the cathode. In some systems, a plurality of cells can be coupled in series, which may or may not be within a single fuel cell unit, to provide a desired voltage. For commercially viable fuel cells, it is desirable to have electrodes that can function within desirable parameters for extended periods of time on the order of 1000 hours or even more.

Fuel cells are a particularly attractive power supply because they can be efficient, environmentally safe and completely renewable. Metal/air fuel cells can be used for both stationary and mobile applications, such as all types of electric vehicles. Fuel cells offer advantages over internal combustion engines, such as zero emissions, lower maintenance costs, and higher specific energies. Higher specific energies can result in weight reductions. In addition, fuel cells can give vehicle designers additional flexibility to distribute weight for optimizing vehicle dynamics.

### SUMMARY OF THE INVENTION

In a first aspect, the invention pertains to an electrochemical cell comprising an electrolyte, an anode, a cathode, a separator and a case. In this embodiment, the anode can comprise metal particles and the aqueous electrolyte in a flowable suspension, and the cathode can comprise a catalytic layer and a non-gaseous oxidizing agent having a reduction potential greater than the reduction potential of the metal particles in the anode. In one embodiment, the catalytic layer can comprise a catalyst in a polymer binder. In some embodiments, the case can comprise a channel with fluid communication between the anode and the exterior of the cell.

In a further aspect, the invention pertains to a gas diffusion electrode for an electrochemical cell comprising a porous backing layer, a catalytic layer coupled to the backing layer and a compositionally distinct redox layer adjacent to the catalytic layer. In one embodiment, the catalytic layer can comprise a matrix polymer and catalyst particles which catalyze the reduction of a gaseous oxidizing agent. In some embodiments, the redox layer comprises an initial oxidizing agent having a reduction potential greater than the reduction potential of a metal.

In addition, the invention pertains to a method for producing current from an electrochemical cell comprising an anode and a cathode. In this embodiment, the method comprises generating current through a closed circuit connecting the anode and the cathode by oxidizing metal particles at the anode and reducing an initial oxidizing agent at the cathode when a suitable concentration of a gaseous oxidizing agent is not present in the cathode. In one embodiment, the method further comprises providing the gaseous oxidizing agent to the electrochemical cell such that when a suitable concentration of the gaseous oxidizing agent is within the electrochemical cell, the electrochemical cell generates current by oxidizing the metal particles at the anode and reducing the gaseous oxidizing agent at the cathode. In one embodiment, the initial oxidizing agent can have a reduction potential greater than the reduction potential of the metal particles. In some embodiments, the gaseous oxidizing agent can comprise oxygen.

### BRIEF DESCRIPTION OF THE DRAWINGS

FIG. 1 is a side view of an embodiment of a gas diffusion electrode showing a redox layer operably coupled to a catalytic layer.

FIG. 2 is a side view of an embodiment of a gas diffusion electrode showing an initial oxidizing agent instilled within the pores of a catalytic layer.

FIG. 3 is a schematic diagram of a metal-air fuel cell designed for the continuous replenishment of metal fuel, in which a sectional side view of an anode is shown in phantom lines.

FIG. 4 is a sectional view of the fuel cell of FIG. 3 showing a cathode, in which the section is taken along line 4-4 of FIG. 3.

FIG. 5 is a sectional side view of an electrode assembly with a current collector embedded within one layer of an electrode assembly comprising an electrode backing layer and an active electrode layer.

FIG. 6 is a sectional side view of an electrode assembly with a current collector embedded between layers of an electrode assembly comprising an electrode backing layer an active electrode layer.

FIG. 7 is a sectional side view of an electrode assembly with a current collector embedded within the surface of one layer of an electrode assembly comprising an electrode backing layer and an active electrode layer, in which the current collector is embedded adjacent to the interface between layers.

FIG. 8 is a sectional side view of an electrode assembly with a current collector embedded within the surface of one layer of an electrode assembly comprising an electrode backing layer and an active electrode layer, in which the current collector is embedded in the surface opposite the interface between the layers.

FIG. 9 is a sectional side view of an electrode assembly with a current collector attached along the free surface of one layer of an electrode assembly comprising an electrode backing layer and an active electrode layer.

FIG. 10 is a sectional side view of an electrode assembly with a current collector attached along one surface of a redox layer.

FIG. 11 is a sectional side view of an electrode assembly with a current collector located between a backing layer/catalytic layer structure and a redox layer.

### DETAILED DESCRIPTION OF THE INVENTION

Improved metal/air fuel cells have an anode and a cathode in which the cathode provides for gas diffusion and reduction of oxygen with a catalyst and comprises an initial oxidizing agent having a half cell reduction potential greater than the reduction potential of a metal in the anode. The initial oxidizing agent can be a non-gaseous composition present in the cathode for immediate availability. Due to the presence of the initial oxidizing agent, the metal/air fuel cells can produce current immediately after being started, regardless of the level, or concentration, of oxygen present in the catalytic layer of the cathode. In other words, the improved fuel cell can produce current without the time delay that can be associated with the flow of oxygen from outside the fuel cell into the cathode catalytic layer. In one embodiment, the initial oxidizing agent can be incorporated into the catalytic layer, while in other embodiments the initial oxidizing agent may form at least a part of a redox layer that is associated with the catalytic layer.

The gas diffusion electrodes can further comprise a porous backing layer operably coupled to the catalytic layer. In embodiments of the gas diffusion electrode without a redox layer, the catalytic layer is also the active layer, while in embodiments comprising a redox layer, both the catalytic layer and the redox layer can be active layers. Generally, the catalytic layer comprises a matrix polymer and catalyst particles that can catalyze the reduction of oxygen. The catalytic layer and backing layer of the gas diffusion electrodes are porous to gases such that gases can penetrate through the backing layer and into the catalytic layer. However, the backing layer of the electrodes are generally sufficiently hydrophobic to prevent diffusion of the electrolyte solution into or through the backing layer. The matrix polymer of the catalytic layer generally is porous, and the porosity of the matrix polymer is generally introduced during processing of the matrix polymer by, for example, the use of shear forces or pore forming agents.

In some embodiments, the initial oxidizing agent can be instilled into the matrix polymer during processing of the catalytic layer and/or after the layer is formed. Alternatively or additionally, the initial oxidizing agent may be introduced into the catalytic layer by dissolving the initial oxidizing agent in a suitable solvent or dispersing a suspension of the initial oxidizing agent in a suitable dispersant, and coating the catalytic layer with the solvent/initial oxidizing agent solution. Once the solvent evaporates, the initial oxidizing agent can be disposed in the pores of the catalytic layer.

In further embodiments, the initial oxidizing agent may be located in a separate redox layer which can be operably coupled to the catalytic layer. In one embodiment, the redox layer can comprise a polymeric binder material and an initial oxidizing agent located within the polymeric binder, while in other embodiments the redox layer can be a porous layer of the initial oxidizing agent, such as a solid grid or powder held between the catalytic layer and the separator. In embodiments where the redox layer comprises a polymeric binder material and an initial oxidizing agent, the initial oxidizing agent can be introduced into the polymeric binder during processing of the polymeric binder. Additionally or alternatively, the initial oxidizing agent can be introduced into the polymeric binder material by dissolving/dispersing the initial oxidizing agent in a suitable solvent and coating the solvent onto the polymeric binder. In general, the redox layer may be formed simultaneously or separately from the catalytic layer/backing layer structure.

A metal fuel cell is a fuel cell that uses a metal, such as zinc particles, as fuel. In an alkaline metal fuel cell, the fuel is generally stored, transmitted and used in the presence of an electrolyte, such as potassium hydroxide solution. Specifically, in metal-air batteries and metal-air fuel cells, oxygen is reduced at the cathode, and metal is oxidized at the anode. In some embodiments, oxygen is supplied as air. For convenience, air and oxygen are used interchangeably throughout unless a specific context requires a more specific interpretation. The gas diffusion electrodes described herein are suitable for catalyzing the reduction of oxygen at a cathode in fuel cell or battery, and also contain an initial oxidizing agent which allows the fuel cell to generate current when there is insufficient oxygen in the cathode. The improved fuel cell electrode assemblies are particularly suited for use as cathodes in zinc-air fuel cells. Due to the ability of the improved fuel cells to generate current when there is insufficient oxygen, the improved fuel cells can generate current immediately upon closing of the circuit connecting the anode and the cathode.

In metal-air fuel cells that utilize zinc as the fuel, the following reaction takes place at the anodes:

Zn+4OH⁻→Zn(OH)₄²⁻+2e⁻ (1)

The two released electrons flow through a load to the cathode where the following reaction takes place:

$$\frac{1}{2} {O}_{2} + 2 {e}^{-} + {H}_{2} O -> 2 {OH}^{-} \qquad ( 2 )$$

The reaction product is the zincate ion, Zn(OH)₄²⁻, which is soluble in the reaction solution KOH. The overall reaction which occurs in the cell cavities is the combination of the two reactions (1) and (2). This combined reaction can be expressed as follows:

$$Zn + 2 {OH}^{-} + \frac{1}{2} {O}_{2} + {H}_{2} O -> {Zn ( OH )}_{4}^{2 -} \qquad ( 3 )$$

Alternatively, the zincate ion, Zn(OH)₄²⁻, can be allowed to precipitate to zinc oxide, ZnO, a second reaction product, in accordance with the following reaction:

Zn(OH)⁴²⁻→ZnO+H₂O+2OH⁻ (4)

In this case, the overall reaction which occurs in the cell cavities is the combination of the three reactions (1), (2), and (4). This overall reaction can be expressed as follows:

$$Zn + \frac{1}{2} {O}_{2} -> ZnO \qquad ( 5 )$$

Under ambient conditions, the reactions (4) or (5) yield an open-circuit voltage potential of about 1.4V. For additional information on this embodiment of a zinc/air battery or fuel cell, the reader is referred to U.S. Pat. Nos. 5,952,117; 6,153,329; and 6,162,555, which are hereby incorporated by reference herein as though set forth in full.

The reaction products of the above reactions can optionally be provided to a regeneration unit, which can reprocess the reaction products to yield oxygen and zinc particles. Specifically, the reaction product Zn(OH)₄²⁻ and/or possibly ZnO or other zinc compounds, can be reprocessed with the application of an external EMF, for example, from line voltage, to yield oxygen and zinc particles. The regenerated zinc particles can optionally be stored in a fuel storage unit. The fuel storage unit can be operably coupled to the fuel cells in order to supply the regenerated fuel to the electrodes.

It should be appreciated that embodiments of metal fuel cells other than zinc fuel cells or the particular form of zinc fuel cell described above are possible for use in a system according to the invention. For example, aluminum fuel cells, lithium fuel cells, magnesium fuel cells, iron fuel cells, sodium fuel cells, and the like are possible. The invention may also be applied to metal-air batteries of all types, and to batteries such as zinc-batteries. Similary, other gaseous oxidizing agents other than oxygen, such as molecular bromine, can be used.

In general, electrodes, and specifically cathodes for the reduction of oxygen in alkaline electrolytes, are usually comprised of three layers. The first layer is a porous catalytic, or active, layer which is infiltrated with a mixture of electrolyte and air/oxygen. The second layer is a backing layer that is placed between the catalytic layer and the air flow. The backing layer is generally impervious to electrolyte, but permeable to gas. The third layer is an electrically conducting mesh, or current collector, that provides electrical contact with other cell components. Furthermore, the catalytic layer is often comprised of a mixture of catalyzed carbon, and/or other catalyst particles, and a matrix polymer material, for example, Teflon®, where the matrix polymer material is processed in such a manner as to bind the catalyst into a porous layer.

The reduction of oxygen occurs in the catalytic layer, and therefore oxygen generally has to flow through the backing layer and into the catalytic layer before the electrochemical cell can generate current. Thus, in some electrochemical cells, there can be a time delay between start up and current generation due to the time requirement to obtain a sufficient oxygen concentration in the catalytic, or active, layer. Generally, it is desirable to seal the fuel cell to air, when in the rest state, to protect the zinc fuel from oxidation by oxygen diffusing through the cell and to reduce the cell voltage to lower the shunt current. In some applications, this time delay in generating current is not desirable. In particular, this time delay is not desirable in fuel cells designed to be used with applications that do not draw a continuous, or steady, amount of current, such as, for example, backup power supplies which are designed to start following the failure of the primary power supply.

As described herein, this time delay can be reduced or eliminated by incorporating an initial oxidizing agent in the cathode that has a reduction potential greater than the reduction potential of the metal in the anode. The initial oxidizing agent can allow the cathode half reaction to take place in the absence of a suitable concentration of oxygen, or other gaseous oxidizing agent, in the cathode, by providing a composition that can be reduced. The reduction of the initial oxidizing agent at the cathode can allow the metal particles in the anode to be oxidized, which ultimately permits the electrochemical cell to generate current in the absence of a suitable concentration of oxygen. The initial oxidizing agents can be, for example, metal oxides, metal hydroxides, other metal compositions or combinations thereof. Certain metal oxides or hydroxides are desirable since they can be regenerated by reaction with oxygen if oxygen is subsequently supplied as an oxidizing agent. Suitable initial oxidizing agents include, for example, Ag₂O and Cu₂O. In embodiments employing, for example, Ag₂O, the following reaction can take place at the cathode in the absence of a suitable concentration of a gaseous oxidizing agent:

Ag₂O+2e⁻+H₂O 2Ag+2OH⁻ (6)

In some embodiments, the initial oxidizing agent can be selected such that the reduced form of the initial oxidizing agent has a reduction potential lower than the reduction potential of the gaseous oxidizing agent. In these embodiments, when oxygen, or another gaseous oxidizing agent, is introduced into the catalytic layer and/or redox layer, the reduced initial oxidizing agent can be oxidized to regenerate the original initial oxidizing agent, such that the initial oxidizing agent is available at later times for quickly starting the fuel cell. In these embodiments, the voltage supplied by the redox couple of the initial oxidizing agent and the metal of the anode is generally less than the voltage supplied by oxygen and the metal in the anode at appropriate oxygen levels. However, the regeneration of the initial oxidizing agent by reaction with oxygen provides a continuing supply of an initial oxidizing agent for starting the fuel cell.

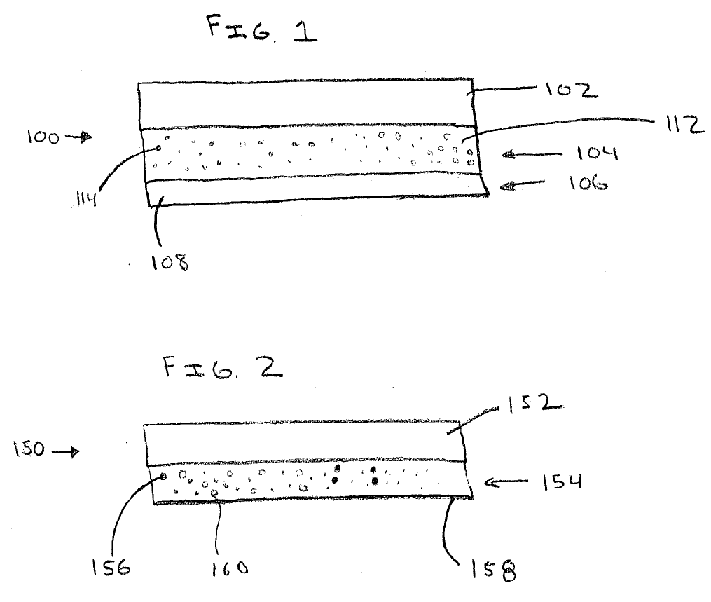

As shown in FIG. 1, in one embodiment, the electrode composition 100 can comprise a backing layer 102, a catalytic layer 104 and a redox layer 106. Backing layer 102, catalytic layer 104 and redox layer 106 are attached together to form an electrode assembly. In this embodiment, redox layer 106 comprises an initial oxidizing agent 108. In one embodiment, initial oxidizing agent can be a layer or grid composed of the initial oxidizing agent, while in other embodiments initial oxidizing agent can be instilled into a polymeric binder material. As shown in FIG. 1, redox layer 106 can be attached to one side of catalytic layer 104, however, other embodiments are possible where, for example, redox layer 106 is located within catalytic layer 106 or between catalytic layer 106 and backing layer 102. In one embodiment, catalytic layer 104 can comprise a matrix polymer 112 and catalyst particles 114 suitable for catalyzing the reduction of a gaseous oxidizing agent such as oxygen. Generally, backing layer 102, catalytic layer 104 and optional redox layer 106 are porous to gasses, and catalytic layer 104 redox layer 106 are electrolyte accessible. Additionally, the catalytic layer 104 and the redox layer 106 generally comprise conductive particles such as, for example, conductive carbon, which provide electrical conductivity for the layer.

Referring to FIG. 2, in some embodiments, gas diffusion electrode 150 comprises a backing layer 152 and a catalytic layer 154 comprising an initial oxidizing agent 156. Catalytic layer 154 further comprises matrix polymer 158 and catalyst particles 160 located within matrix polymer 158. In one embodiment, initial oxidizing agent 156 can be instilled into matrix polymer 158. In some embodiments, the catalytic layer further comprises conductive particles such as, for example, conductive carbon, located within the matrix polymer.

As is described in more detail below, a matrix polymer can be any polymer suitable for forming a porous particle binder. More specifically, suitable matrix polymers for the electrode composition can be homopolymers, copolymers, block copolymers, polymer blends and mixtures thereof. Various polymers are suitable for porous electrode fabrication in fuel cells and batteries. In embodiments based on fibrillatable polymers, suitable polymers include, for example, fluorinated polymers and blends and copolymers thereof. In embodiments involving extrusion or molding, pore formers are agents that are compatible with the polymer in the sense that the pore former can be dispersed through the polymers mass and co-molded with the polymer. The pore former or a portion thereof is then removed to leave behind pores or voids in the locations at which the pores formers were located. In all of the embodiments, the particular components in the compositions and the processing conditions can be selected to yield particularly desired characteristics for resulting electrode material.

In some embodiments, an ion conducting polymer can be instilled into the pores of matrix polymer to prevent osmotic pressure build up in the cathode. The use of ion conducting polymers in the catalytic layer of gas diffusion electrodes is described in, for example, co-pending application Ser. No. 10/364,768, filed on Feb. 11, 2003, titled “Fuel Cell Electrode Assembly,” which is hereby incorporated by reference. In some embodiments, the electrode composition further comprises a current collector that electrically couples the components of the electrochemical cell. Generally, electrically conductive particles, such as, for example, conductive carbon, are incorporated into matrix polymer 158.

As described above, in some embodiments, the gas diffusion electrodes comprise a redox layer. In one embodiment, the redox layer can comprise an initial oxidizing agent instilled into a polymeric binder material. Generally, the polymeric binder of the redox layer can be any polymeric material suitable for binding the initial oxidizing agent. Suitable polymers include, for example, homopolymers, copolymers, block copolymers, polymer blends and mixtures thereof. The specific choice of a polymeric binder material will generally be guided by the selection of a particular initial oxidizing agent 108 and the desired properties of the gas diffusion electrode.

To form the gas diffusion electrodes, electrically conductive particles are included to provide the electrical conductivity. Generally, reasonably high loading levels can be used to obtain desired levels of electrochemical conductivity, as described further below. For gaseous reactants, catalysts can be included within the electrode material to catalyze the reaction of gaseous reactants. The hydrophobicity of the electrode composition can be controlled to correspondingly control the amount of wetting of the electrode by the electrolyte. The electrode backing layer can optionally include electrically conductive particles and can be gas permeable. However, the electrode backing layer generally is more hydrophobic such that the electrolyte/reaction medium does not penetrate past the backing layer. Thus, the electrode backing layer can form a barrier to electrolyte loss through evaporation and/or flow from the cell.

In general, the catalytic layer, redox layer and the backing layer of the electrode can be formed separately or simultaneously, for example, by coextrusion. In addition, in one embodiment, the redox layer can be coupled to the catalytic layer before, after or when the catalytic layer is coupled to the backing layer. In some embodiments, the backing layer and the catalytic layer can be produced simultaneously and the redox layer can be produced separately. In these embodiments, the redox layer can be operably coupled, for example, by lamination, to the catalytic/backing layer composition after the catalytic/backing layer composition has been formed.

In one embodiment, the catalytic layer can be formed by initially producing a mixture, or paste, that comprises catalyzed carbon particles, or other catalyst and/or electrically conductive particles, and a matrix polymer material. Similarly for the formation of the backing layer, a binder polymer can be optionally combined with electrically conductive particles in a mixture. Additionally, in one embodiment, the redox layer can also be formed by producing a paste, or mixture, comprising an initial oxidizing agent and a polymeric binder material. In some embodiments, the redox layer may also comprise electrically conductive particles. The mixture is generally formed into a porous sheet. For compression molding, a pore forming agent should be selected such that the liquid pore former does not phase separate from the polymer and remains well dispersed within the polymer. In other embodiments where the matrix polymer and/or the polymeric binder material comprise a fibrillatable polymer, the desired level of porosity can be introduced by shear forces. Shear forces can be applied, for example, by extrusion and/or calendaring. Methods of fibrillating polymers by calendaring are described in commonly assigned and co-pending application Ser. No. 10/288,392 titled “Gas Diffusion Electrodes,” filed on Nov. 5, 2002, which is hereby incorporated in its entirety.

For processing, a layer of an electrode composition can comprise liquid processing aids. In some embodiments, the liquid is an aqueous liquid, such as water. If a surfactant is used, the surfactant is generally soluble in the liquid. Some or all of the liquid is ultimately removed to leave a porous structure that is at least gas permeable. The use of liquid processing aids is described further in the above noted patent application titled “Gas Diffusion Electrodes.”

In one embodiment, for the formation of the catalytic layer, the porous matrix polymer/catalyzed carbon layer can be combined with an initial oxidizing agent so as to instill the initial oxidizing agent into the matrix polymer. The initial oxidizing agent should be instilled into the matrix polymer such that oxygen, or other appropriate oxidizing gasses, can flow into the catalytic layer. One method for incorporating an initial oxidizing agent into the catalytic layer comprises dissolving the initial oxidizing agent in a solvent and subsequently coating the surface of the catalytic layer with the solvent/initial oxidizing agent mixture. The contact with the solution results in the deposition of the initial oxidizing agent into the matrix polymer. For processing of the catalytic layer, the choice of solvent used to dissolve the initial oxidizing agent will be generally determined by the particular initial oxidizing agent and matrix polymer being employed. In some embodiments, the solvent(s) used during processing can be removed, for example, by evaporation, such that the final electrode compositions will be substantially free of solvents.

Alternatively or additionally, the initial oxidizing agent can be introduced during the formation of the catalytic layer such that it naturally is disposed within the matrix polymer when the layer is formed. For example, in some embodiments, a mixture is formed by mixing the matrix polymer, catalyst particles, such as catalyzed carbon and/or other catalyst particles, and/or electrically conducting particles, with an initial oxidizing agent in the presence of a liquid lubricant. A matrix polymer, e.g. Teflon®, could be added to promote binding of the catalyzed carbon/initial oxidizing agent blend. The matrix polymer/catalyzed carbon/initial oxidizing agent blend can then be further processed into a sheet or other desired shape for use as the catalytic layer in electrode compositions.

In embodiments where the initial oxidizing agent is located in the matrix polymer, the backing layer can be attached to the matrix polymer before or after the initial oxidizing agent/solvent mixture is applied to the matrix polymer. Depending on the presence of the initial oxidizing agent, the processing conditions for the attachment of the backing layer to the catalytic layer can be selected appropriately. If the catalytic layer and backing layer are separately formed, the backing layer and the catalytic layer can be laminated together, for example, by calendaring and/or by an adhesive. Alternatively or additionally, the catalytic layer, which in one embodiment comprises an initial oxidizing agent, a matrix polymer and a catalyst, can be co-extruded with the backing layer.

The electrode assembly can then be assembled into a cell. Formation of a cell generally involves assembly of two electrode assemblies to function as an anode and a cathode with a separator between the two electrode assemblies. A separator can be integral with one electrode assembly and can be positioned appropriately to separate the anode and cathode of a cell. The separator is an electrically insulating structure. Suitable commercial materials for formation of separators include, for example, Freudenberg FS-2224-R, a polypropylene non-woven cloth (Freudenberg Group of Companies), Freudenberg FS-2115, a polyamide non-woven cloth, Crane CC21.0, a polyethylene sulfide non-woven cloth, Hollingsworth & Vose BP5053-W, a polyethylene/polypropylene mixture non-woven cloth (Hollingsworth & Vose Company, East Warpole, Mass.) UCB Cellophane, a poly non-woven cellophane cloth (UCB Cellophane Ltd., UK) Celgard 3401, polypropylene with a surfactant microporous membrane (Celgard Inc., Charlotte, N.C.); and CN 20/20, an acrylate grafted polyethylene non-porous membrane.

For embodiments with a gaseous fuel, the anode comprises a catalytic layer, a backing layer and an electrolyte solution. In some embodiments, the structure and/or composition of the anode and the cathode are different from each other. In embodiments of particular interest, the cathode comprises a gas diffusion electrode, and the anode comprises an electrode structure comprising metal particles. One or more cell structures can be placed within a housing along with an electrolyte. The current collectors are generally connected for parallel or series connection of the cells.

An advantage of fuel cells relative to traditional power sources such as lead acid batteries is that they can provide longer term primary and/or auxiliary/backup power more efficiently and compactly. This advantage stems for the ability to continuously refuel the fuel cell using fuel stored within the fuel cell, from some other source, and/or regenerated from reaction products using a regeneration unit. In the case of metal fuel cells, for example, the duration of time over which the energy can be provided is limited only by the amount of fuel and reaction medium which is initially provided in the fuel cell storage unit, which is fed into the system during replacement of a fuel cell storage unit, and/or which can be regenerated from the reaction products that are produced. Thus, a fuel cell system comprising at least one fuel cell that comprises an optional regeneration unit and/or replacement fuel storage unit, can provide auxiliary/backup power to one or more loads for a time in the range from about 0.01 hours to about 10,000 hours, or ever more.

Fuel cells may be used to power a load which, as used herein, includes, for example and without limitation, telecommunications equipment, Internet servers, corporate mail servers, routers, power supplies, computers, test and industrial process control equipment, alarm and security equipment, many other types of electrical devices, equipment for which a power source is necessary or desirable to enable equipment to function for its intended purpose, and the like, and suitable combinations of any two or more thereof. Additional examples of loads include lawn & garden equipment; radios; telephone; targeting equipment; battery rechargers; laptops; communications devices; sensors; night vision equipment; camping equipment (stoves, lanterns, lights); lights; vehicles (both primary and auxiliary power units, with or without regeneration unit on board, and with or without capability of refueling from a refueling station, including without limitation, cars, recreational vehicles, trucks, boats, motorcycles, motorized scooters, forklifts, golf carts, lawnmowers, industrial carts, passenger carts (airport), luggage handling equipment (airports), airplanes, lighter than air crafts (e.g. blimps, dirigibles, etc.,), hovercrafts, trains (locomotives), and submarines (manned and unmanned); torpedoes; and military-usable variants of above.

Structure for Zinc-Air Fuel Cell

A metal-air fuel cell involves oxidation of metal at the anode and reduction of oxygen at the cathode. The metal can be replenished such that the cell can continue to function indefinitely. Thus, the fuel cell system comprises a metal delivery section that can be operably connected with the fuel cell. The fuel cell unit comprises at least one anode and cathode spaced apart with a separator, which are all in contact with an electrolyte. Generally, the fuel cell unit is in a housing that provides for appropriate air-flow, maintenance of the electrolyte, connection with the metal delivery section and electrical contact to provide electrical work.

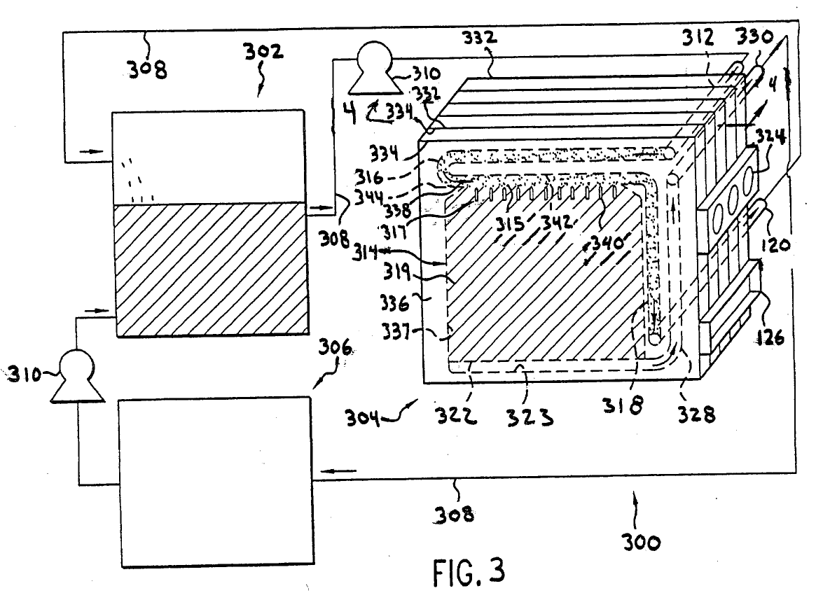

A particular embodiment of a zinc-air fuel cell system 300 is shown in FIG. 3. The zinc-air fuel system 300 comprises a zinc fuel tank 302, a zinc-air fuel cell stack or power source 304, an electrolyte management unit 306, a piping system 308, one or more pumps 310, and one or more valves (not shown) that define a closed flow circuit for the circulation of zinc particles and electrolyte during fuel cell operation. The zinc fuel tank 302, the electrolyte management unit 306, or a combination of these and/or other system components, may be a separable, detachable part of the system 300.

Zinc pellets in a flow medium, such as concentrated potassium hydroxide (KOH) electrolyte solution, are located in the zinc fuel tank 302. In another implementation, the particles can be a type of metal other than zinc, such as aluminum (aluminum-air fuel cell), lithium (lithium-air fuel cell), iron (iron-air fuel cell), or a particulate material other than metal that can act as an oxidant or reductant. In other embodiments, the flow medium is a fluid, e.g., liquid or gas, other than an electrolyte.

The zinc and electrolyte solution can be, for example, pulsed, intermittently fed, or continuously fed from the zinc fuel tank 302, through the piping system 308, and into an inlet manifold 312 of the cell stack 304. Piping system 308 can comprise one or more fluid connecting devices, e.g., tubes, conduits, elbows, and the like, for connecting the components of system 300.

Power source 304 comprises a stack of one or more bipolar cells 314, each generally defining a plane and coupled together in series. Each cell 314 has an open circuit voltage determined by the reduction and oxidation reactants within the cell along with the cell structure, which can be expressed as M volts. Assuming that the open circuit potential of all the cells are equal, power source 304 has an open-circuit potential P equal to M volts ×N cells, where N is the number of cells in power source 304.

Zinc-air fuel cell 314 interfaces with a fuel cell frame or body 336. The fuel cell body 336 generally forms a fuel cell cavity 337. Each cell 314 includes an air positive electrode or cathode 332 that occupies can entire surface or side of cell 314 and a zinc negative electrode or anode 334 that occupies an opposite entire side of cell 314. The cathode and anode are separated by an electrically insulating separator. A porous and electrically conductive film may be inserted between the electrodes 332, 334 of adjacent cells such that air can be blown through the film for supplying oxygen to each air positive electrode 332.

The bipolar stack 304 may be created by simply stacking cells 314 such that the current collector of negative electrode 334 of each cell is in physical contact with the positive electrode surface 332 of adjacent cell 314, with the porous and electrically conductive substance there between. With this structure, the resulting series connection provides a total open circuit potential between the first negative electrode 334 and the last positive electrode 332 of P volts. With these structures, extremely compact high voltage bipolar stacks 304 can be constructed. Furthermore, since no wires are used between cells 314 and since electrodes 332, 334 comprise large surface areas, the internal resistance between cells is extremely low.

The interface between one positive electrode 332 and piping system 308 through inlet manifold 312 is shown in phantom lines in FIG. 3. Inlet manifold 312 can run through cells 314 of power source 304, for example, perpendicular to the planes defined by the cells. Inlet manifold 312 distributes fluidized zinc pellets to cells 314 via conduits or cell filling tubes 316. Each inlet conduit 316 lies within its respective cell 314.

The zinc particulates and electrolyte flow through a flow path 315 in each cell 314, generally within the plane of the cell. The method of delivering particles to the cells 314 is a flow-through method. A dilute stream of pellets in flowing KOH electrolyte is delivered to the flow path 315 at the top of the cell 314 via conduit 316. The stream flows through flow path 315, across the zinc particle bed, and exits on the opposite side of cell 314 via outlet tube 318. Some of the pellets in the stream are directed by baffles 340 into electroactive zone 319. Pellets that remain in the flow stream are removed from cell 314. This flow through method, along with baffles 340, allows the electroactive zone 319 to occupy substantially all of the cell cavity and remain substantially constantly filled with zinc particles. As a result, the electrochemical potential of each cell 314 is maintained at desired levels per cell cavity volume. Pumps 310 can be used to control the flow rate of electrolyte and zinc through system 310. The fuel cell cavity communicates with inlet manifold 312 via cell filling tube 316.

As the zinc particles dissolve in electroactive zone 319 of cell 314, a soluble zinc reaction product, zincate, is produced. The zincate passes through a screen mesh or filter 322 near a bottom 323 of cell 314 and is washed out of the active area of cell 314 with electrolyte that also flows through cell 314 and filter 322. Screen mesh or filter 322 causes the electrolyte that exits cell 314 to have a negligible amount or no zinc particles. The flow of electrolyte through cell 314 not only removes the soluble zinc reaction product and, thereby, reduces precipitation of discharge products in the electrochemical zone 319, it also removes unwanted heat, helping to prevent cell 314 from overheating.

Electrolyte exits cell 314 and cell stack 304 via an electrolyte outlet conduit 128 and electrolyte manifold 130, respectively. The electrolyte is drawn into electrolyte management unit 306 through piping system 308. A pump (not shown) may be used to draw electrolyte into the electrolyte management unit 306. Electrolyte management unit 306 can be used to remove zincate and/or heat from the electrolyte so that the same electrolyte can be added to the zinc fuel tank 302 for zinc fluidation purposes. Electrolyte management unit 306, like zinc fuel tank 302, may be part of an integral assembly with the rest of system 300, or it may be a separate, detachable part of system 300.

A constant supply of oxygen is required for the electrochemical reaction in each cell 314. To effectuate the flow of oxygen, one embodiment of system 300 can include a plurality of air blowers 324 and an air outlet 326 on the side of cell stack 304 to supply a flow of air comprising oxygen to the positive air electrodes/cathodes of each cell 314. A porous substrate such as a nickel foam may be disposed between each cell 314 to allow the air to reach the air cathode of each cell and to flow through the stack 304. In other embodiments, an oxidant other than air, such as pure oxygen, bromine or hydrogen peroxide, can be supplied to a cell 314 for the electrochemical reaction.

A sectional view of system 300 in FIG. 4 displays a positive air electrode/cathode 332 within one cell 314 of cell stack 304. Positive air electrode 332 is held with cell 314 within fuel cell frame 336. A non-porous divider 360 separates gas inflow from air blowers 324 from air outlets 326. Frame 336 forms an inlet chamber 362 and an outlet chamber 364. Inlet chamber 362 and outlet chamber 364, respectively, form passageways from positive air electrode 332 to air blowers 324 and air outlets 326. A gas permeable membrane 366 can be placed between air chambers 362, 364 and electrode 332 to reduce or prevent loss of electrolyte through flow out of the cell and/or evaporation.

While certain configuration of the positive air electrode/cathode are suitable for use in the fuel cell of FIG. 3, a broader range of gas diffusion electrode structures are generally useful and are described further below.

Electrode Assembly Structure And Materials

An electrode assembly of the present disclosure generally comprises a catalytic layer attached to a backing layer, and optionally can comprise a redox layer attached to the catalytic layer. An initial oxidizing agent, which generally has a half cell reduction potential greater than the reduction potential of a metal in the anode, can be located in the catalytic layer, the redox layer, or both. The catalytic layer comprises catalyst particles for catalyzing the reduction of oxygen and/or other gaseous reactants. Generally, the cathode reaction takes place in the catalytic layer, however, in the absence of a suitable concentration of oxygen, the cathode reaction may take place in the optional redox layer. The backing layer is generally porous, which permits gaseous reactants to permeate to the catalytic layer. The backing layer can also prevent electrolyte from diffusing out of the catalytic layer through the backing layer. In some embodiments, the electrode assembly also comprises a current collector and a separator. A current collector generally functions to reduce the overall electrical resistance of the electrode assembly, while the separator provides a means of electrically separating the components of the electrode, and in particular, separating the cathode and the anode.

The catalytic layer of a gas diffusion electrode generally comprises a matrix polymer and catalyst particles. As mentioned above, in some embodiments, the catalytic layer can also comprise an initial oxidizing agent, which allows the fuel cell to generate current in the absence of an appropriate concentration of oxygen in the catalytic layer to provide desired redox activity. In some embodiments, the catalytic layer can also comprise electronically conductive particles held together by the matrix polymer. The electrode composition can further comprise additional materials to facilitate processing and/or to form a structure with desired properties. The electrode composition can be formed into an electrode assembly by combining the electrode composition with a current collector and/or additional electrode layers. The electrode composition is typically formed into a structure with a generally planar aspect with a thickness that is significantly smaller than the dimensions across the face of the planer structure.

In some embodiments, for the formation of a catalytic layer, the dry electrode composition generally comprises in the range(s) from about 5 weight percent to about 50 weight percent of polymer and in further embodiments, in the range(s) from about 10 weight percent to about 35 weight percent. In additional embodiments, for the formation of an electrode backing layer, the dry cathode composition generally comprises in the range(s) from about 40 weight percent to about 90 weight percent polymer. In embodiments employing a redox layer with a polymer binder, the dry redox layer generally comprises from about 10 weight percent to about 80 weight percent polymer. A person of ordinary skill in the art will recognize that additional ranges of the solid phase of the active, backing and redox layers are contemplated and are within the present disclosure.

In general, the matrix polymer can be any polymer suitable for forming a porous particle binder. The matrix polymer can be a homopolymer, copolymer, block copolymer or polymer blend or mixture. Suitable matrix polymers include, but are not limited to, poly(ethylene), poly(tetrafluoroethylene), poly(propylene) and poly(vinylidene fluoride). Other suitable matrix polymers include styrene block copolymers including, for example, styrene-isoprene-styrene, styrene-ethylene-butylene-styrene and styrene-butadiene-styrene. Suitable styrene block copolymers are sold under the trade name KRATON®.

For the processing of the cathode material by calendaring and/or extrusion, the matrix polymer can be a fibrillatable polymer. Suitable fibrillatable polymers include, for example, polytetrafluoroethylene (e.g., Teflon®9B, 602A, 610A, 612A, 640, K-10, CFP6000, 60, 67, and NXT (DuPont), Halon™ and Algoflon™ (Ausimont USA), Fluon™ (ICI America Inc.), Hostaflon™ (Hoechst Celanese) and Polyflon™ (Daikan)), polypropylene, polyethylene (generally high or ultrahigh molecular weight), ethylene-tetrafluoroethylene copolymer (e.g., Tefzel™ (DuPont) and Halon™ET (Ausimont, USA)), fluorinated ethylene propylene copolymer (e.g., as sold by DuPont), ethylene-chlorotrifluoro ethylene copolymer (e.g., Halar™ (Ausimont USA)), perfluoroalkoxy (e.g., as sold by DuPont), and blends or copolymers thereof. In some embodiments of interest, fibrillatable polymers are supplied for forming the electrode composition with average particle sizes in the range(s) from about 0.1 microns to about 500 microns. A person of ordinary skill in the art will recognize that additional ranges within this explicit range of particle sizes are contemplated and are within the present disclosure.

For compression molding processing of the electrode composition, fibrillatable polymers may or may not be used. Suitable matrix polymers for compression molding include, for example, epoxies, styrene-poly(ethylene-butylene)-styrene triblock copolymer (e.g., Kraton®G (Shell)), styrene-butadiene-styrene triblock copolymer (e.g., Kraton®D (Shell)), phenolics (supplied by Capital Resins Corp.), modified polyphenylene oxide-styrene Noryl® supplied by General Electric), polytetrafluoroethylene (e.g., Teflon®9B, 602A, 610A, 612A, 640, K-10, CFP6000, 60, 67, and NXT (DuPont), Halon™ and Algoflon™ (Ausimont USA), Fluon™ (ICI America Inc.), Hostaflon™ (Hoechst Celanese) and Polyflon™ (Daikan)), modified ethylene chlorotrifluoroethylene (Vatar®, Ausimont USA), polyfurans (QO Chemicals), melamine (Oxidental Chemical), perfluoromethylvinylether (Hyflon®, Ausimont USA) and perfluoroalkoxy (Hyflon®, Ausimont USA). For metal-air cell applications, the polymers generally are selected to be relatively chemically inert after long exposure to high concentrations of OH⁻ at elevated temperatures and in the presence of electric fields.

In some embodiments, a redox layer is coupled to the catalytic layer. The redox layer should be coupled to the catalytic layer so that the oxygen, or other suitable gasses, can penetrate through the catalytic layer and into the redox layer. In general, the redox layer comprises an initial oxidizing agent. In some embodiments, the initial oxidizing agent can be instilled within a polymeric binder material to form the redox layer, however, other embodiments are possible where the initial oxidizing agent comprises a metal oxide powder that is applied directly to the catalytic layer. In some embodiments, the redox layer may comprise additional materials such as, for example, stabilizers, plasticizers and combinations thereof. In embodiments in which the redox layer comprises a polymer, suitable matrix polymers are described above. Additionally, the redox layer can comprise conductive particles, such as, for example, conductive carbon, to provide electrical conductivity to the layer.

In general, the initial oxidizing agent can be a metal oxide, metal hydroxide, other metal composition, or combination thereof, that has a reduction potential greater than the reduction potential of the metal particles in the anode. Suitable initial oxidizing agents for cells based on an oxygen gaseous oxidizing agent include, for example, Ag₂O, Cu₂O, Ni(OH)₂, PbO₂ and combinations thereof. For fuel cells based on different gaseous oxidizing agents appropriate initial oxidizing agents can be similarly selected. For example, for a bromine (Br₂) based fuel cell, suitable initial oxidizing agents include, for example, AuBr, AgBr, PbBr₂, and combinations thereof. Additional initial oxidizing agents can be selected from standard reduction potential tables. In some embodiments, two or more different initial oxidizing agents may be incorporated into a cathode. The selection of a particular initial oxidizing agent will be generally guided by the choice of metal particles in the anode. Additionally, the initial oxidizing agent may be selected such that the reduced form of the initial oxidizing agent has a reduction potential lower than reduction potential of a gaseous oxidizing agent such as, for example, oxygen. In these embodiments, when the gaseous oxidizing agent flows into the electrode structure, the reduced form of the initial oxidizing agent can be oxidized, which can regenerate the initial oxidizing agent.

In embodiments employing a redox layer, the dry redox layer can comprise from about 5 weight percent to about 100 weight percent of the initial oxidizing agent. In other embodiments, the dry redox layer can comprise from about 10 weight percent to about 75 weight percent, and in further embodiments the redox layer can comprise from about 35 weight percent to about 60 weight percent initial oxidizing agent. In embodiments employing a redox layer, the dry redox layer can comprise from about 0 weight percent to about 50 weight percent electrically conductive particles. In some embodiments, the dry redox layer can comprise from about 10 weight percent to about 40 weight percent conductive particles. Generally, the thickness of the redox layer can be from about 2 microns to about 1 millimeter. One of ordinary skill in the art will recognize that additional ranges of composition and thickness within these explicit ranges are contemplated and are within the present disclosure.

For catalytic electrode layers, the dry electrode layer generally can comprise no more than about 80 weight percent electrically conductive particles and in further embodiments from about 20 weight percent to about 70 weight percent electrically conductive particles. For electrode backing layers, the dry electrode composition generally can comprise in the ranges from about 0 weight percent to about 50 weight percent electrically conductive particles and in further embodiments from about 5 weight percent to about 40 weight percent electrically conductive particles. A person of ordinary skill in the art will recognize that other ranges of concentration of electrically conductive particles are contemplated and are within the present disclosure.

The electrically conductive particles can comprise carbon conductors, such as carbon black, other carbon particles, metal particles, conductive metal compounds, conductive ceramics, or combinations thereof. Electrically conductive particles of particular interest comprise carbon black with a BET (Brunauer-Emmett-Teller) surface area in the ranges of at least about 200 m²/g, and in other embodiments from about 300 m²/g to about 1500 m²/g. A person of ordinary skill in the art will recognize that additional ranges of surface areas within the explicit ranges are contemplated and are within the present disclosure. Suitable carbon blacks generally include, for example, acetylene blacks, furnace blacks, thermal blacks and modified carbon blacks. Commercial carbon blacks generally are sold with specified BET surface areas, as measured by accepted ASTM test procedures. In addition, the carbon blacks can have an electrical resistivity as measured by accepted techniques by carbon black vendors of no more than about 0.01 ohm-cm. Furthermore, the carbon black may have an internal volume as determined by a DBP (dibutyl phthalate) absorption test of at least about 150 cm³/100 gm, and in other embodiments at least about 300 cm³/100 gm, wherein the internal volume is determined as set forth in standard test procedure ASTM D-2414-79. Specific suitable carbon blacks include, for example, ABC-55 22913 (Chevron Phillips, Houston, Tex.), Black Pearls (Cabot, Billerica, Mass.), Ketjen Black (Akzo Nobel Chemicals Inc., Chicago, Ill.), Super-P (MMM Carbon Division, Brussels, Belgium), Condutex 975® (Columbia Chemical CO., Atlanta, Ga.), Printex XE (Degussa Corp., Ridgefield Park, N.J.) and mixtures thereof. In general, the electrically conductive particles, for example, carbon black, can be spherical, rod-shaped or any other suitable shape or combinations of shapes yielding an appropriate surface area and conductivity. For electrode applications, carbon black properties of particular interest include, for example, electrical conductivity, porosity and hydrophobicity. The characteristics and concentration of electrically conductive particles are generally selected to provide low electrical resistance, which is generally thought to result from obtaining conditions exceeding a percolation threshold, although not wanting to be limited by theory. Factors that influence electrical conductivity of electrical particles in a matrix include, for example, geometry of the matrix, crystallinity of the matrix, interactions between the electrical particles and the matrix, size and shape of the particles, surface area, degree of dispersion and concentration.

In general, the particulate components need not be homogenous materials, and may be blends of materials, such as blends varying in particle size, shape and/or surface area, which can be used to impart desired electrical, physical and processing properties.

While the electrically conductive particles may also function as catalysts for the reduction of, for example, molecular oxygen, generally a specific catalyst material is added to an active electrode layer. Catalysts, as described herein, broadly cover any material(s) that can catalyze a reduction-oxidation reaction. If two materials each provide electrical conductivity and catalytic activity, it may be arbitrary, which is called electrically conductive particles and which is called a catalyst. However, it may be desirable to add one material primarily as a catalyst and a second material primarily as an electrically conductive material. In some embodiments, the solid phase of the electrode composition can comprise in the range(s) less than about 50 weight percent, in other embodiments in the range(s) from about 45 weight percent to about 5 weight percent and in further embodiments in the range(s) from about 10 weight percent to about 40 weight percent. A person of ordinary skill in the art will recognize that additional ranges within these explicit ranges are contemplated and are within the present disclosure. Suitable catalysts include, for example, elemental metal particles, metal compositions, and combinations thereof. Suitable metals broadly cover all recognized metal elements of the periodic table and alloys thereof. Exemplary metals include without limitation, Fe, Co, Ag, Ru, Mn, Zn, Mo, Cr, Cu, V, Ni, Rh, and Pt. Suitable metal compositions include, for example, permanganates (e.g., AgMnO₄ and KMnO₄), metal oxides (e.g., Mn₂O₃, spinels, such as CO₃O₄, rutile structures, such as MnO₂, and perovskites, such as La_{0.5}Sr_{0.5}MnO₃), decomposition products of metal heterocycles (e.g., iron tetraphenylporphyrin, cobalt tetramethoxyphenylporphyrin, cobalt complexes (e.g., tetramethoxyphenyl porphyrin (CoTMPP)), perovskites, cobalt pthalocynanine and iron pthalocynanine) and napthenates (e.g., cobalt napthenates and manganese napthenate) and combinations thereof. Elemental metals are un-oxidized metals in their zero oxidation state, i.e., M⁰. Suitable elemental metal particles include, for example, Ag, Pt, Pd, Ru, alloys thereof and combinations thereof. In general, the catalyst particles can be spherical, rod-shaped or any other suitable shape or combinations of shapes yielding an appropriate surface area.

Some metals for use as catalysts have a high cost. Therefore, cost savings can result from coating the elemental metal onto a less expensive particulate. For example, metals can be coated onto carbon black. In some embodiments, the catalysts comprise in the range(s) of at least about 80 weight percent carbon black and no more than about 20.0 weight percent metal, and in other embodiments from about 94.95 weight percent to about 99.9 weight percent carbon black, in further embodiments in the range(s) from about 0.1 weight percent to about 5.0 weight percent metal and in the range(s) from about 0.05 to about 5 weight percent nitrogen. To form the catalyst, carbon black is contacted with vapors of metal precursors and nitrogen precursors in a reducing environment. The metal may or may not be in elemental form and the carbon black may or may not be chemically bonded to metal and/or the nitrogen. The carbon black materials described above are also suitable for forming these catalyst materials. The carbon black-metal-nitrogen containing catalysts are further described in copending and commonly assigned U.S. patent application Ser. No. 09/973,490 to Lefebvre, entitled “Methods of Producing Oxygen Reduction Catalyst,” incorporated herein by reference.

The electrode can optionally comprise additional materials, generally each at a concentration of no more than about 5 weight percent. Potential additional materials include, for example, fillers, processing aids, stabilizers, and the like and combinations thereof. Additionally, in some embodiments of the present invention the electrode composition comprises a friction reducing or anti-wear agent as a processing aid.

In general, catalytic layers are more hydrophilic than the backing layers. For example, the backing layers can be essentially pure polymers that are hydrophobic, such as poly(tetrafluoroethylene), poly(ethylene), poly(propylene), poly(vinylidene fluoride) or mixtures and copolymers thereof. Generally, the catalytic layer is sufficiently hydrophilic to provide for movement though the layer of electrolyte and ionic species. The backing layer is generally sufficiently porous to allow gasses, for example oxygen, to diffuse through it, while also being sufficiently hydrophobic to prevent liquids such as electrolytes from passing through. In some embodiments, the backing layer can comprise particles, such as electrically conductive particles, within a porous water resistant composite.

For formation of an electrode, the electrode composition generally is formed into a sheet shape with a thickness much less than the linear dimensions defining the extent of the planar surfaces of the electrode. In some embodiments, the electrode has an average thickness in the range(s) of no more than 5 millimeters (mm), in additional embodiments in the range(s) of no more than about 3 mm, and in other embodiments in the range(s) of no more than about 2 mm, in further embodiments in the range(s) from about 1.5 mm to about 0.05 mm and in additional embodiments in the range(s) from about 1 mm to about 0.01 mm. A person of ordinary skill in the art will recognize that additional ranges of electrode thickness and uniformity within these explicit ranges are contemplated and are within the present disclosure.

The thickness may or may not be approximately constant across the face of the electrode. In some embodiments, the smallest edge-to-edge distance across the face of an electrode through the center of the electrode face is at least about 1 centimeter (cm). The shape of the face of the electrode can have any convenient shape, such as circular, oval or rectangular, for assembly into a galvanic cell or other device. In some embodiments, the electrode is roughly rectangular, although one or more of the edges may not be straight and one or more of the corners may or may not be square. For assembly into some embodiments of commercial fuel cells, it is desirable to have the smallest edge-to-edge distance across the face of the electrode though the center of the electrode to be in the range(s) of at least about 1 cm, in other embodiments in the range(s) of at least about 10 cm and in further embodiments in the range(s) from about 14 cm to about 200 cm. A person of ordinary skill in the art will recognize that additional ranges of electrode dimensions are contemplated and are within the present disclosure.

A current collector is a highly electrically conductive structure that is combined with the catalytic layer, the redox layer and/or backing layer to reduce the overall electrical resistance of the electrode assembly. Suitable current collectors can be formed from elemental metal or alloys thereof, although they can, in principle be formed from other materials. While in some embodiments a metal foil or the like can be used as a current collector, for gas diffusion electrodes, it is generally desirable to have a current collector that is permeable to the gaseous reactants such that the gas can flow through the cell. Thus, in some embodiments, the current collector comprises a metal mesh, screen, wool or the like. Suitable metals for forming current collectors that balance cost and convenience include, for example, nickel, aluminum and copper, although many other materials, metals and alloys can be used, as noted above. The current collector generally extends over a majority of the face of the electrode composition and may comprise a portion that extends beyond the electrode composition, for example, a tab that can be used to make an electrical connection to the current collector. In some embodiments, the current collector may be positioned between the catalytic layer and backing layer, while in other embodiments the current collector can be positioned between the catalytic layer and the redox layer. Additionally or alternatively, the current collectors may be embedded in backing, catalytic or redox layer. In some embodiments, a plurality of current collectors may be associated with a cathode assembly. For example, a first current collector can be associated with the catalytic layer and a second current collector can be associated with the redox layer.

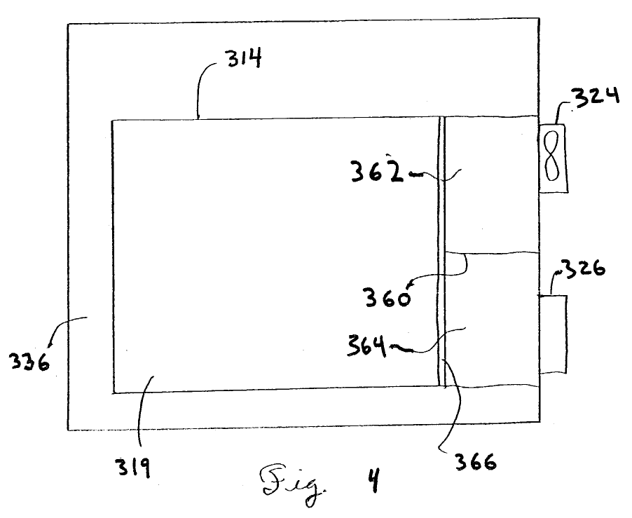

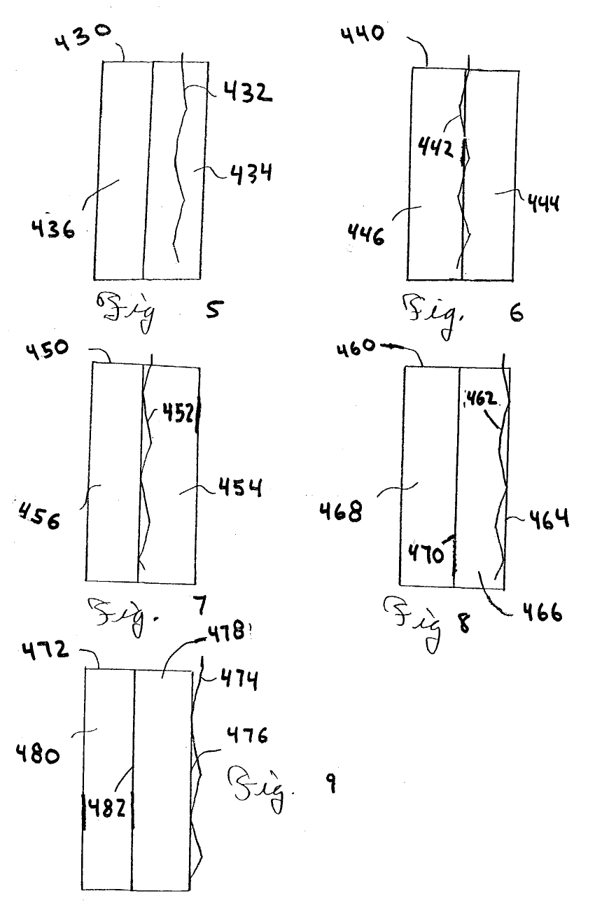

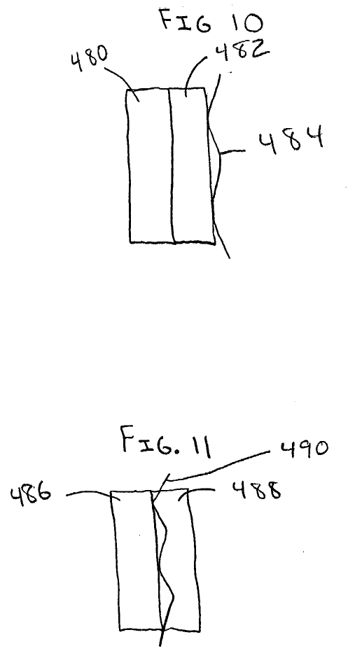

In some embodiments, the electrode assembly comprises a plurality of layers with different electrode compositions, such as, for example, a catalytic electrode layer and/or an electrode backing layer, a plurality of catalytic electrode layers and/or a plurality of electrode backing layers, or a backing layer, an catalytic layer and a redox layer. The current collector can be placed in one or more positions within the electrode assembly. Some representative structures are shown in FIGS. 5-11. Referring to FIG. 5, electrode assembly 430 comprises a current collector 432 embedded within a catalytic layer 434 and a backing layer 436 adjacent the catalytic layer 434. Referring to FIG. 6, electrode assembly 440 comprises a current collector 442 embedded approximately within a catalytic layer 444 and a backing layer 446 at the interface between electrode compositions 444, 446. Referring to FIG. 7, electrode assembly 450 comprises a current collector 452 embedded below a face an catalytic layer 454 and a backing layer 456 adjacent the same face of the catalytic layer 454. Referring to FIG. 8, electrode assembly 460 comprises a current collector 462 embedded below a first face 464 of an catalytic layer 466 and a backing layer 468 adjacent second face 470 of the catalytic layer 466. Referring to FIG. 9, electrode assembly 472 comprises a current collector 474 attached to a first face 476 of an catalytic layer 478 and a backing layer 480 adjacent a second face 482 of the catalytic layer 478.

In some embodiments, a redox layer can be associated with a backing layer/catalytic layer structure. Referring to FIG. 10, in one embodiment, backing layer/catalytic layer structure 480 can be attached to one face of redox layer 482. In this embodiment, current collector 484 can be attached to a second face of redox layer 482. In another embodiment, as shown in FIG. 11, backing layer/catalytic layer 486 can be coupled to one face of current collector 490. In this embodiment, a second face of current collector 490 can be attached to redox layer 488. In some embodiments, two or more current collector may be positioned with an electrode assembly. Additional or alternative embodiments comprising a plurality of catalytic electrode layers, a plurality of electrode backing layers, a plurality of redox layers, and/or a plurality of current collectors can be formed by straightforwardly generalizing the basic structures shown in FIGS. 5-11.

The Gurley number is a measurement of the porosity of a material. Lower values of Gurley numbers reflect a greater porosity, as described further below. Gurley numbers of at most about 200 can be desirable in some embodiments for an electrode backing layer. Gurley number can be evaluated, for example, with an instrument from Gurley Precision Instruments, Troy, N.Y.

Processing to Form Electrode Assembly

The processing of the electrode composition and/or the electrode assembly comprises combining the components of the electrode composition, forming the desired electrode structure(s) and optionally combining the components to form an electrode assembly. In general, an electrode assembly comprises a catalytic layer, a backing layer, a current collector and optionally a redox layer. For the processing of a layer, the formation of a fibrillated structure using a fibrillatable polymer generally comprises the application of sufficient shear to result in the desired fibrillation. The fibrillation can result in the desired porosity while obtaining desired mechanical properties of the electrode composition and good binding of particulates. The desired shear can be applied in one or more steps that can comprise, for example, high shear mixing, extruding, and/or calendaring. At least some of the shaping of the electrode composition can be performed simultaneously with the application of the shear. Additionally or alternatively, the electrode composition can be shaped using molding such as compression molding. Similar approaches can be used to simultaneously process the active, redox and backing layers following formation of the combined structure, for example, by coextrusion.

In some embodiments, the electrode composition can comprise a fluid phase and a solid phase. The fluid phase comprises a fluid and, optionally, compositions dissolved within the fluid. The solid phase includes everything not in the fluid phase. The fluid phase can be, for example, a liquid or a gas that diffuses out by applying suitable conditions, such as heat, or by dissolution of the fluid from the electrolyte. In some embodiments, the electrode composition comprises a weight ratio of fluid phase to solid phase in the range(s) of no more than about 20.0, in other embodiments, in the range(s) of no more than 10.0, and in further embodiments in the range(s) from about 9.0 to about 0.05 and in some embodiments in the range(s) from about 3.5 to about 1.5. A person of ordinary skill in the art will recognize that additional range(s) within these explicit range(s) are contemplated and are within the present disclosure. The electrode composition can have a greater ratio of fluid to solid during the mixing stages relative to other stages of processing. At the completion of the electrode preparation, the electrode may or may not be devoid of fluid. In some embodiments, the electrode following drying may have no more than about 5 weight percent liquid.

Generally, the components of the electrode compositions are combined and mixed, although not all components need to be combined simultaneously. In some embodiments, an optional initial oxidizing agent can be mixed with the matrix polymer, the catalyst, optional processing aid and conductive material to form the catalytic layer in a single step. In other embodiments, the catalyst, the matrix polymer and optionally other processing aids are mixed and processed to form a porous sheet and the initial oxidizing agent is applied to the catalytic layer following formation of the catalytic layer. Additionally or alternatively, the initial oxidizing agent can located in a separate redox layer, which can be formed separately or simultaneously with the catalytic layer and/or backing layer. Before mixing, the powders can be pulverized, for example, using an air impact pulverizer. Suitable air impact pulverizers include, for example, Tost Model T-15 manufactured by Plastomer Technologies (Newton, Pa.) or a Rotomill model 1000 or model 1300 manufactured by International Process Equipment Co. (Pennsauken, N.J.). The formation of the backing layer can be similar to the formation of the catalytic layer except that the backing layer does not include catalyst particles.

In some embodiments, the matrix polymer, the polymeric binder material in embodiments employing a redox layer, or both, can result in a high viscosity of the processing composition such that the mixing requires considerable shear to combine the ingredients. The mixing can be performed in corresponding mixing apparatuses that can impose the corresponding shear. For example, the mixing or a portion thereof can be performed in a blender or a mill or the like. Generally, the mixture is mixed for sufficient time to form an approximately homogenous paste. The specific amount of time can be selected based upon the particular equipments and processing conditions. Liquid components can be added or removed at one or more points in the processing and can be added to replace liquid lost during processing and/or to alter the processing properties.

Following blending of the solid components, the electrode composition can be shaped. In some embodiments, the mixture is extruded through a die. Various extruders can be used, such as a twin screw extruder, a ram extruder and the like. Suitable ram extruders include, for example, ram extruders from, for example, Jennings Corporation (Norristown, Pa.), or from WK Worek U.S.A. (Ramsey, N.J.). In some embodiments, the extrusion generally is performed at pressures in the range(s) of no more than about 50,000 psi gauge (psig), in other embodiments in the range(s) of no more than about 10,000 psig and in further embodiments in the range(s) from about 1,500 psig to about 6,000 psig. For ram extrusion, the corresponding velocity of the ram extruder can be in the ranges of at least about 3 cm/sec and in further embodiments from about 5 cm/sec to about 100 cm/sec. A person of ordinary skill in the art will recognize that additional ranges of extrusion pressures and ram velocities within the explicit ranges are contemplated and are within the present disclosure. In some embodiments, the extrusion can be performed through a die opening.

The die opening of the extruder can have any reasonable shape, such as a slit, a circle, an oval or the like. The size and shape of the die opening determines the characteristics of the electrode composition for further processing. While the die opening can have a variety of possible shapes, in some embodiments, the die has a shape of a rectangular slit with a dimension corresponding to the thickness of the extrudate in the range(s) of no more than about 3 cm, in other embodiments in the ranges of no more than about 5 millimeters (mm), and in additional embodiments in the range(s) from about 2.5 mm to about 0.05 mm. A person of ordinary skill in the art will recognize that additional ranges within these explicit ranges are contemplated and are within the present disclosure.

The extrusion can be performed at any temperature in which the electrode composition has a sufficiently low viscosity that the composition can be extruded to allow fibrillation of the matrix polymer system and/or the polymeric binder system in embodiments employing a redox layer. In some embodiments, the extrusion is performed at room temperature or at an elevated temperature. In embodiment in which the extrusion is performed at an elevated temperature, the temperature can be in the range(s) from about 25° C. to about 150° C., in other embodiments in the range(s) from about 30° C. to about 80° C., and in further embodiments in the range(s) from about 40° C. to about 70° C. A person of ordinary skill in the art will recognize that additional ranges within these explicit ranges are contemplated and are within the present disclosure.

The mixing and optional extruding apply shear to the fibrillatable matrix polymer and/or polymeric binder that can induce fibrillation of the polymer. In addition, in the some embodiments, extrusion can shape the electrode composition to have a particular thickness and shape or geometry. However, even in embodiments in which the electrode composition is extruded, it may be desirable to calendar the electrode composition. Calendaring broadly includes passing the composition through a gap, generally formed by opposing pairs of moving members. Suitable moving members include, for example, rollers, belts and the like.

The electrode shape and size are selected to be appropriate for the corresponding cell into which the electrode is placed. The electrodes materials can be selected and processed to produce electrodes with approximately the desired shape and size. In alternative embodiments, the electrodes can be cut to the desired sizes using available cutting tools.

Additionally or alternatively, electrode structures can be formed by compression molding. To perform the compression molding, the electrode materials are generally formed into a paste as described above using a mixer. The paste is then transferred to the mold of a compression molding apparatus. Compression molding has been used for the formation of electrodes for batteries using PTFE binders. See, for example, U.S. Pat. No. 6,413,678 to Hamamoto, et al., entitled “Non-Aqueous Electrolyte And Lithium Secondary Battery Using The Same,” U.S. Pat. No. 6,001,139 to Asanuma, et al., entitled “Nonaqueous Secondary Battery Having Multiple-Layered Negative Electrode, and U.S. Pat. No. 5,705,296 to Kamauchi, et al., entitled “Lithium Secondary Battery,” all three of which are incorporated herein by reference. An electrode structure comprising a catalytic layer, a backing layer, and optionally a redox layer can be formed by placing the appropriate compositions adjacent each other in the mold.

In some embodiments, the initial oxidizing agent is dissolved/dispersed into a solvent/dispersant and then coated onto the catalytic layer. Any appropriate means for coating can be used to apply the solution/dispersion with the initial oxidizing agent to the porous matrix polymer including, for example, spraying or dip coating. In this embodiment, the solvent can be, for example, a suitable commercially available solvent/dispersant that can dissolve/disperse the initial oxidizing agent while not adversely changing the structure of the catalytic layer. Generally, the choice of solvent/dispersant depends upon the specific matrix polymer and initial oxidizing agent being used. In some embodiments, the solvent/dispersant may be a polar solvent, such as water or a polar organic solvent. The solvent/dispersant used to dissolve/disperse the initial oxidizing agent should be selected such that the solvent/dispersant will not adversely affect or degrade the pores that have been formed in the matrix polymer. In some embodiments, a solvent/dispersant for dissolving/dispersing the initial oxidizing agent and/or a liquid processing aid for assisting with the processing of the matrix polymer may be present when the initial oxidizing agent/solvent mixture is applied to the porous layer. The solvent/dispersant for the initial oxidizing agent may and the processing aid may or may not be the same as a liquid processing aid for the processing of the mixture of the matrix polymer and catalyst particles. In these embodiments, the solvent/dispersant used to dissolve/disperse the initial oxidizing agents generally is selected to be compatible with other liquids and/or solvents present in the catalytic layer as well as the matrix polymer and catalyst particles.

In embodiments employing a redox layer, the initial oxidizing agent can be introduced, for example as a powder, into a polymeric binder material during processing of the polymeric binder material. For example, silver oxide power is commercially available. Processing of the polymeric binder material generally involves the application of shear forces by, for example, extrusion to produce a porous polymeric structure. Additionally or alternatively, the initial oxidizing agent can be introduced into the pores of the polymeric binder material after the processing of the material by, for example, the use of solvents/dispersants. The use of solvents/dispersants to dissolve/disperse and coat the catalytic layer with the initial oxidizing agent has been described above, and these methods can also be used for introducing the initial oxidizing agent into the pores of the polymeric binder material of the redox layer.

In other embodiments, the redox layer comprises an initial oxidizing agent without a polymer binder. For example, the initial oxidizing agent can be a metal oxide powder, for example silver oxide, that can be coated directly onto the catalytic layer. In other embodiments, the initial oxidizing agent can be cast into a grid structure using an appropriate solvent to dissolve the compound which is placed into a mold or the like to introduce the desired shape. The grid then can be attached to the catalytic layer. The initial oxidizing agent can be coated onto to the catalytic layer, or grid structure, by any generally known means for depositing powders including, for example, spraying the catalytic layer with a powder/carrier solvent mixture.

In some embodiments, the electrode compositions can be dried to remove processing aids and solvents added during formation of the electrode. In embodiments that involve fiction reducing agents or other processing aids, the drying step will permit the evaporation of these process aids as well as any solvent(s) used to form or process the electrode composition. As a result, some embodiments of the final electrode composition will be substantially free of solvents, processing aids and other fluids. In other embodiments, the electrode composition comprises less than about 5 weight percent processing aids, viscosity modifiers, stabilizers, solvents, and the like and combinations thereof. In further embodiments, the electrode composition can comprise from about 5 weight percent to about 10 weight percent viscosity modifiers, stabilizers, processing aids and the like. In embodiments where the initial oxidizing agent is instilled into pores of either the matrix polymer or polymeric binder material by dissolving the initial oxidizing agent in a suitable solvent, the resulting layer can be dried before or after the layer is combined with other layers to form an electrode assembly.

The electrode composition can be associated with a current collector to form an electrode assembly. The electrode assembly can comprise various structures as described above. The association can be performed with an electrically conductive adhesive, such as a carbon particle-containing adhesive/polymer. Alternatively or additionally, the current collector can be associated with one or more electrode compositions by laminating the current collector to the electrode composition(s) for example in a press, with a calendar apparatus or the like. Laminating the current collector with one or more electrode compositions may or may not result in a reduction of the thickness of the electrode composition. The lamination can be repeated, if necessary, to achieve a desired level of adherence of the current collector. Similarly, the pressure in a press and the gap dimensions of a calendar can be selected to yield a desired level of adherence.

Furthermore, the electrode, with or without the current collector, can be associated with the backing layer and/or a separator. In some embodiments, it is desirable for the degree of adherence of the catalytic layer to the backing layer, and in some embodiments, the catalytic layer to the redox layer, to exceed the tensile strength of the materials of one or both of the layers themselves. In particular, the electrode can be combined with one or more of these other elements of an electrode assembly through lamination, for example, through a calendar. Suitable roller speeds for this lamination are, for example, from about 0.01 rpm to about 10 rpm or in other embodiments from about 0.3 rpm to about 5 rpm, and suitable temperatures are in the range(s) from about 50° C. to about 330° C. A person of ordinary skill in the art will recognize that additional ranges within these particular ranges are contemplated and are within the present disclosure. If the initial oxidizing agent is present when the lamination is performed, the temperature can be selected such that the initial oxidizing agent is not adversely affected. The catalytic layer can also be laminated to the backing layer, for example, through the use of a heat press or through calendaring. Similarly, the optional redox layer can be laminated to the catalytic layer by, for example, a heat press. One suitable heat press is the Carver Laboratory Press model 4128 (Carver, Inc.). Alternatively or additionally, the backing layer can be attached to the catalytic layer with adhesives. Any commercially available adhesive, such as an electrically conducting adhesive, that does not interfere with the function of the electrode can potentially be used to attach the backing layer to the catalytic layer, or the catalytic layer to the optional redox layer.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

We claim:

1. An electrochemical cell comprising:
an electrolyte;
an anode comprising metal particles and the electrolyte in a flowable suspension;
a cathode comprising a catalytic layer and a non-gaseous oxidizing agent having a reduction potential greater than the reduction potential of the metal particles in the anode wherein the catalytic layer comprises a catalyst in a polymer binder;
a separator between the anode and the cathode; and
a case comprising a channel with fluid communication between the anode and the exterior of the cell.

2. The electrochemical cell of claim 1 wherein the metal particles comprise zinc, an alloy of zinc or a combination thereof.

3. The electrochemical cell of claim 1 wherein the gas diffusion electrode further comprises a backing layer coupled to the catalytic layer.

4. The electrochemical cell of claim 3 wherein the backing layer comprises a polymer.

5. The electrochemical cell of claim 3 wherein the backing layer comprises a polymer selected from the group consisting of poly(ethylene), poly(tetrafluoroethylene), poly(propylene), poly(vinylidene fluoride), and blends and copolymers thereof.

6. The electrochemical cell of claim 1 wherein the polymer binder comprises a fluorinated polymer.

7. The electrochemical cell of claim 1 wherein the polymer binder comprises a perfluoronated polymer.

8. The electrochemical cell of claim 1 wherein the polymer binder comprises poly(tetrafluoroethylene).

9. The electrochemical cell of claim 1 wherein the catalyst comprises an elemental metal, a permanganate, a metal oxide, a decomposition product of a metal heterocycle, a cobalt complex, a napthenate or a combination thereof.

10. The electrochemical cell of claim 1 wherein the catalytic layer further comprises conductive carbon.

11. The electrochemical cell of claim 1 wherein the non-gaseous oxidizing agent comprises a metal oxide, metal hydroxide or a combination thereof.

12. The electrochemical cell of claim 1 wherein the non-gaseous oxidizing agent comprises Ag₂O, Cu₂O, Ni(OH)₂, PbO₂ or combinations thereof.

13. The electrochemical cell of claim 1 wherein the non-gaseous oxidizing agent comprises AuBr, AgBr, PbBr₂, or a combination thereof.

14. The electrochemical cell of claim 1 wherein the separator comprises a porous polymer.

15. The electrochemical cell of claim 1 further comprising a current collector.

16. The electrochemical cell of claim 1 wherein the electrolyte comprises an aqueous solution comprising hydroxide ions.

17. The electrochemical cell of claim 1 wherein the non-gaseous oxidizing agent is located within the catalytic layer.

18. The electrochemical cell of claim 1 wherein the non-gaseous oxidizing agent is adjacent the catalytic layer.

19. A gas diffusion electrode for an electrochemical cell, the electrode comprising:
a porous backing layer;
an catalytic layer coupled to the backing layer, the catalytic layer comprising a matrix polymer and catalyst particles which catalyze the reduction of a gaseous oxidizing agent; and
a compositionally distinct redox layer adjacent to the catalytic layer, wherein the redox layer comprises an initial oxidizing agent having a reduction potential greater than the reduction potential of a metal.

20. The gas diffusion electrode of claim 19 wherein the matrix polymer comprises a hydrophobic polymer.

21. The gas diffusion electrode of claim 19 wherein the matrix polymer comprises a fluorinated polymer.

22. The gas diffusion electrode of claim 19 wherein the matrix polymer comprises a perfluorinated polymer.

23. The gas diffusion electrode of claim 19 wherein the matrix polymer comprises poly(tetrafluoroethylene).

24. The gas diffusion electrode of claim 19 wherein the catalyst comprises an elemental metal, a permanganate, a metal oxide, a decomposition product of a metal heterocycle, a cobalt complex, a napthenate or a combination thereof.

25. The gas diffusion electrode of claim 19 wherein the catalytic layer further comprises conductive carbon.

26. The gas diffusion electrode of claim 19 wherein the catalytic layer further comprises the initial oxidizing agent located within the matrix polymer.

27. The gas diffusion electrode of claim 19 wherein the initial oxidizing agent comprises a metal oxide, a metal hydroxide or a combination thereof.

28. The gas diffusion electrode of claim 19 wherein the initial oxidizing agent comprises Ag₂O, Cu₂O, Ni(OH)₂, PbO₂ or combinations thereof.

29. The gas diffusion electrode of claim 19 wherein the initial oxidizing agent comprises AuBr, AgBr, PbBr₂, or a combination thereof.

30. The gas diffusion electrode of claim 19 wherein the redox layer further comprises a polymeric binder material that binds the initial oxidizing agent within the polymeric binder material.

31. The gas diffusion electrode of claim 30 wherein the polymeric binder material comprises a polymer selected from the group consisting of poly(ethylene), poly(propylene), poly(tetrafluoroethylene), poly(vinylidene fluoride), polystyrene, and blends and copolymers thereof.

32. The gas diffusion electrode of claim 19 wherein the redox layer comprises a metal oxide powder on the surface of the catalytic layer.

33. The gas diffusion electrode of claim 19 wherein the initial oxidizing agent has a reduction potential lower than the reduction potential of the gaseous oxidizing agent.

34. The gas diffusion electrode of claim 19 wherein the redox layer further comprises conductive particles.

35. A method for producing current from an electrochemical cell comprising an anode and a cathode, the method comprising:
generating current through a closed circuit connecting the anode and the cathode by oxidizing metal particles at the anode and reducing a initial oxidizing agent at the cathode when a suitable concentration of a gaseous oxidizing agent is not present in the cathode, wherein the initial oxidizing agent has a reduction potential greater than the reduction potential of the metal particles; and
providing the gaseous oxidizing agent to the electrochemical cell such that when a suitable concentration of the gaseous oxidizing agent is within the electrochemical cell, the electrochemical cell generates current by oxidizing the metal particles at the anode and reducing gaseous oxidizing agent at the cathode.

36. The method of claim 35 wherein the gaseous oxidizing agent oxidizes the reduced initial oxidizing agent to regenerate the initial oxidizing agent.

37. The method of claim 35 wherein the gaseous oxidizing agent comprises oxygen.
